(19) United States
(12) Patent Application Publication
(10) Pub. No.: US 2026/0091938 A1
(43) Pub. Date: Apr. 2, 2026

(54) A MODULAR STORAGE AND COMMISSIONING SYSTEM

(71) Applicant: stow Robotics GmbH, Großwallstadt (DE)

(72) Inventor: Matthias HEDDINGA, Krummesse (DE)

(21) Appl. No.: 19/114,924

(22) PCT Filed: Sep. 29, 2022
(86) PCT No.: PCT/EP2022/077203

§ 371 Date: Mar. 25, 2025

(51) Int. Cl. B65G 1/137; B65G 1/04

(52) U.S. Cl. CPC B65G 1/1373; B65G 1/0407

(57) ABSTRACT

A modular storage and commissioning system includes a storage arrangement, a commissioning unit and a conveyor system. The storage arrangement has a lower and an upper storage unit which are based on a self-supporting frame structure. The conveyor system is detachably connected to the storage units. The self-supporting frame structures of the storage units support the storage units themselves as well as at least the weight of a further storage unit. The upper storage unit is detachably arranged on top of the lower storage unit. Further, a method assembles the modular storage and commissioning system and a method disassembles the modular storage and commissioning system.

### CROSS REFERENCE TO RELATED APPLICATIONS

This application is a United States National Phase Application of International Application PCT/EP2022/077203, filed Sep. 29, 2022, the entire contents of which are incorporated herein by reference.

### TECHNICAL FIELD

The present invention is directed to a modular storage and commissioning system comprising a storage arrangement for receiving storage containers comprising goods, a commissioning unit with at least one serving station for removing goods from one or more storage containers and a conveyor system for conveying storage containers between the storage arrangement and the commissioning unit. The invention is further directed to a method of assembling a storage and commissioning system as well as a method of disassembling a storage and commissioning system.

### BACKGROUND

DE 10 2017 129 120 A1 discloses a modular storage and commissioning system. The system comprises a storage unit for receiving storage containers. The storage containers are provided for storing different kinds of articles or goods and can be conveyed from the storage unit to a commissioning unit using a conveyor. Here, an operator may remove selected goods or articles from storage containers to form a collection of goods which may, for example, be related to an order of a customer.

The storage unit has a self-supporting frame structure to which the commissioning unit and the conveyor unit can be releasably attached so that the storage and commissioning system can be rapidly assembled and disassembled when needed. This advantageously allows setting up the entire storage and commissioning system within a few hours. Further, due to the modular structure of the system, the individual components can be transported separately and are assembled wherever needed.

### SUMMARY

Against this background it can be considered an object for the skilled person to provide an improved modular storage and commissioning system as well as an improved method for assembling a modular storage and commissioning system and also an improved method for disassembling a storage and commissioning system.

The object is solved by a modular storage and commissioning system with features according to the invention, a method for assembling a modular storage and commissioning system with features according to the invention as well as a method for disassembling a storage and commissioning system with features according to the invention. Preferred embodiments of the invention are the subject matter of the drawings, specification and claims.

In a first aspect the present invention relates to a modular storage and commissioning system comprising a storage arrangement for receiving storage containers comprising goods, a commissioning unit with at least one serving station for removing goods from one or more storage containers and a conveyor system for conveying storage containers between the storage arrangement and the commissioning unit. The storage arrangement comprises a lower storage unit and an upper storage unit. Each storage unit is based on a self-supporting frame structure. The conveyor system is detachably connected to the self-supporting frame structures of the lower storage unit and the upper storage unit. The self-supporting frame structure of the lower storage unit is adapted for supporting the upper storage unit. The upper storage unit is detachably arranged on top of the lower storage unit.

In other words, the modular storage and commissioning system is centered around a storage arrangement in which storage containers can be held. It is also possible to refer to storage containers as bins or storage boxes. The storage containers may all be of identical size but the system is intended for storage containers of different sizes that can be flexibly stored in the storage arrangement.

The storage arrangement is formed from a lower storage unit and an upper storage unit. Each storage unit has a self-supporting frame which may, for example, house a plurality of through-flow channels in which the storage containers are held. The self-supporting frame structure of the lower storage unit further has to be capable of also supporting the upper storage units which is, when the modular storage and commissioning system has been assembled, arranged on top of the lower storage unit. Hence, the upper storage unit is fully supported by the lower storage unit and, more concretely by the self-supporting frame structure of the lower storage unit. Hence, by stacking the upper storage unit on top of the lower storage unit a storage arrangement is obtained which has double the capacity of a modular storage and commissioning system relying on a single storage unit. Further, stacking one storage unit on another storage unit advantageously allows using existing spaces in warehouses more efficiently as most warehouses are of sufficient height to support two stacked storage units.

The conveyor system which is used to move the storage containers from the storage arrangement to the commissioning unit and back is connected to the self-supporting frame structures of the two storage units once the upper storage unit has been stacked on top of the lower storage unit. Releasably attaching the conveyor system to the self-supporting frame structure of the storage units advantageously allows to rapidly install the modular storage and commissioning system but also to disassemble it in a short time and transport it to a different location.

The upper storage unit may be placed directly on top of the lower storage unit. However, in an exemplary embodiment one or more additional storage units are arranged between the lower storage unit and the upper storage unit. In this case, the self-supporting frame structure of the lower storage unit has to be dimensioned so that it can also support the one or more additional storage units. The upper storage unit is then arranged via the additional storage units on top of the lower storage unit. In this exemplary embodiment, the conveyor system would have to be adapted for also conveying storage containers between the additional storage units and the commissioning unit. Using three or more stacked storage units further improves the capacity of storage containers that can be handled by the storage arrangement.

Note that in cases where identical storage units are used as lower, additional and upper storage units, an upper storage unit may become an additional storage unit by placing another storage unit on top of the previously upper storage unit. Similarly, in case an upper storage unit is removed, a previously additional storage unit may become an upper storage unit.

In a preferred embodiment, the lower storage unit and the upper storage unit each have a cuboid outer shape and identical outer dimensions. For example, the storage units could have the dimensions of a twenty-or a forty-foot standardized shipping container. A twenty-foot container has a length of approximately six meters, a width of a approximately 2.4 meters and a height of approximately 2.6 meters. A forty-foot container is approximately 12.1 meters long, of identical width and similar height as a twenty-foot container. Hence, stacking two storage units on top of each other which have a height of approximately 2.6 meters results in an overall height of 5.2 meters of the storage arrangement which easily fits in most warehouses and efficiently uses the space thereof.

In particular, in case the upper and lower storage units as well as any additional storage units have identical dimensions, it may be preferable to make the storage units in structurally identical, in particular, in regard to the load bearing capacity or strength of the self-supporting frame structure of the storage units. This would advantageously allow interchanging the position of the lower and upper storage unit as well as any additional storage units so that each storage unit can be flexibly used as either an upper storage unit, an additional storage unit or a lower storage unit.

Preferably, the conveyor system comprises a first modular transport mast which is movable horizontally along a first side of the storage arrangement for conveying transport containers between the first side of the storage arrangement and the commissioning unit. The conveyor system further preferably comprises a second modular transport mast which is movable horizontally along a second side of the storage arrangement for conveying transport containers between the second side of the storage arrangement and the commissioning unit.

In other words, the conveyor system comprises one and, more preferably, two modular transport masts. These transport masts are attached to opposite sides of the storage arrangement in a way that also allows detaching or disconnecting them from the transport arrangement and, more concretely, from the self-supporting structures of the lower and upper storage units. Each transport mast can be moved horizontally along the respective side of the storage arrangement and comprises at least one container handling device.

It is further preferred that each modular transport mast comprises a lower mast section, a center mast section and an upper mast section. The upper mast section is detachably connected to the lower mast section via the center mast section.

Thus, in the preferred embodiment, the modular transport mast comprises at least three elements: a bottom or lower section, a center section and a top or upper section. The lower and upper mast section are provided for engaging, for example, with guide rails on the storage arrangement. To this end, the mast sections may, for example, comprise rollers and other means for engaging with guide rails or other guidance means on the storage arrangement. The center mast section is placed between the upper and the lower mast section and can, for example, be used to modify the overall length of the transport mast. For example, the different center mast sections can be used to adapt the height of the transport mast from using only one storage unit to a system comprising two or more storage units and also for adapting the transport mast for storage units of different heights.

Preferably, for each transport mast the lower mast section can be detachably connected to the upper mast section either directly or using an alternate center mast section to form a short transport mast so that when the upper storage unit has been removed from the lower storage unit, storage containers can still be conveyed between the lower storage unit and the commissioning unit using the short transport mast.

Hence, in the preferred embodiment the lower mast section and the upper mast section of the transport mast can still be used for conveying transport containers from the lower part of the storage arrangement after the upper part of the storage arrangement formed by the upper storage unit and any potential additional storage units has been removed. Since these parts of the transport mast engage with the guidance means on the storage arrangement, reusing these parts is particularly beneficial. In order to shorten the transport mast for use with a single storage unit only, the upper and lower mast section can either be connected directly or an alternative short center mast section can be used. The latter center mast section also does not have to be visible from the outside but could merely be provided in a form of an internal connection between the upper and the lower transport mast sections.

Thus, the conveyor system contributes to the modularity of the overall storage and commissioning system as it can be reused if the storage and commissioning system has only been partly assembled or already been partly disassembled. This may, for example, be advantageous in case only limited storage capacity is required so that there is no need to stack multiple storage units, i.e., in case only a single storage unit is used.

Each modular transport mast preferably comprises at least one and more preferably two or more container handling devices. Each of the container handling devices is configured to move vertically along the respective modular transport mast. The more preferred two or more container handling devices are further preferably structurally linked so that they stay at constant distance relative to one another while moving along the respective modular transport mast. Alternatively, the two or more handling devices are further preferably configured to move independently but concurrently on the respective modular transport mast.

Hence, in the preferred embodiment each transport mast is equipped with one and preferably more than one container handling device. Each of the container handling devices can be moved vertically up and down the respective modular transport mast on which it is arranged and be used to pick-up and drop-off storage containers at the storage units or the commissioning unit. The combined horizontal movement of the transport mast itself and the vertical movement of the at least one container handling device on the transport mast enables removing containers from all storage positions or storage locations in the upper and lower storage unit.

It is preferred to use not only one container handling device on each transport mast but two or more. The container handling devices can receive in parallel containers from different storage locations in the storage arrangement or from different service stations at the commissioning unit. The container handling devices move concurrently or can move at the same time along the transport mast sections.

Depending on the implementation of the container handling device, the container handling devices may either move independently along the transport mast or their movement may be linked to the movement of the other container handling devices on the same transport mast, for example, by structurally connecting the container handling device. Having multiple independently moving container handling devices improves the speed at which storage containers can be handle. On the other hand, having container handling devices which are structurally linked simplifies operation as the conveyor system while still increasing the number of storage containers that can be handled. Note that even if the container handling devices can move independently, their movement is evidently constrained by the location of the respective other container handling devices.

Since the movement of the container handling devices is not restricted to specific sections of the transport mast, the two container handling devices can be used to convey, for example, two containers from the upper storage unit at the same time to the commissioning unit, two storage containers from an additional storage unit or two storage containers from the lower storage unit to the commissioning unit. Evidently, it is also possible to transport two containers from different storage units to the commissioning unit.

In a preferred embodiment the commissioning unit comprises at least one serving station for each container handling device. The serving stations are configured for temporarily receiving a container from at least one of the container handling devices and enabling an operator of the commissioning unit to remove goods from a container placed on a serving station.

Thus, according to the preferred embodiment the number of serving stations at the commissioning unit at least equals or exceeds the number of container handling devices on the conveyor system. The serving stations are provided in a way on the commissioning unit that each container handling device can reach at least one of the serving stations. The handling device may drop off a storage container removed from the storage arrangement at the respective serving station or retrieve a container from that serving station and transport it back to the storage arrangement. Further, the operator retrieving or removing goods from the storage containers placed at the serving station may be a human or a robotic operator.

In an exemplary preferred embodiment, the number of serving stations is at least double the number of container handling devices. The system is further configured such that each container handling device can reach at least two serving stations. This advantageously enables the container handling device to drop off a storage container at a storage station and retrieve a storage container from a different serving station without having to make empty runs between the commissioning unit and the storage arrangement for either picking up storage containers or dropping off storage containers if there is no space available at a serving station for dropping off storage containers otherwise. Also, it is not necessary for the conveyor system to wait until the operator has removed goods from the lost storage container before the next is picked up.

The system preferably comprises two or more commissioning units. The conveying system is configured so that the first transport mast and/or the second transport mast may convey goods between both commissioning units and the storage arrangement. Hence, in the preferred embodiment the system not only comprises two or more storage units but also two or more commissioning units for improving the rate at which object or goods stored in the storage containers can be assembled from the storage containers as ordered. The commissioning units may, for example, be stacked one on top of the other and the conveying station can be used to also coney storage containers to and from the second commissioning unit. However, the commissioning units could also be placed adjacent to one another on the same horizontal plane.

In a preferred embodiment, the conveyor system comprises for each for each transport mast a set of guide rails for releasably connecting the respective modular transport mast to the transport arrangement and for enabling horizontal movement of the respective modular transport mast along the transport arrangement. Hence, in the preferred embodiment guide rails are used to attach each transport mast to the transport arrangement. For example, the guide rails can be releasably attached to the self-supporting frame structure of the upper and lower transport unit. The transport masts are then attached to the guide rails and can travel along the guide rails in the horizontal direction.

Preferably, each set of guide rails comprises at least one lower guide rail and at least one upper guide rail. The at least one lower guide rail is mounted to the lower storage unit and is configured for engaging with the respective lower mast section. The at least one upper guide rail is mounted to the upper storage unit and is configured for engagement with the respective upper mast section.

The preferred embodiment further defines a way of implementing a set of guide rails for the conveyor system. This set of guide rails comprises at least two guide rails: a lower guide rail and an upper guide rail. The lower guide rail may, for example, be attached to a bottom end of the lower storage unit. The at least one upper guide rail is, for example, attached to an upper end of the upper storage unit.

The upper and the lower guide rail are provided for mounting or supporting one of the mast sections directly of the respective transport mast. The upper and lower mast sections are consequently configured for engaging with the lower and upper guide rails at their respective claims. While not excluded, the present embodiment nevertheless does not foresee that all the center sections of the transport masts are directly connected to a guide rail. Rather, the center mast sections are connected via the upper and the lower mast sections to the guide rails.

In an exemplary preferred embodiment, the system comprises two upper guide rails and two lower guide rails on each side of the transport arrangement so that the mast sections of the transport mast are at either end guided by two guide rails and not just by one. This further increases the robustness of the system as potentially heavy loads in the storage containers are supported by multiple parallel guide rails.

Preferably, each upper guide rail is configured such that when the upper storage unit and any additional storage unit has been removed from the lower storage unit, the respective upper guide rail can be mounted to the lower storage unit such that the short transport mast can be connected via the lower guide rail and the upper guide rail to the lower storage unit.

In other words, in the preferred embodiment the conveyor unit is formed in a way that even if the upper storage unit or any additional storage unit has not been placed on top of the lower storage unit, the upper storage unit has been removed or there is only the lower storage unit available, the guide rails can be re-used for supporting the short transport mast so that the storage and commissioning system is maintained operable. For example, the upper guide rail can be mounted to the upper end of the lower storage unit which allows attaching the short transport mast to the lower transport unit. Hence, horizontal movement of the shortened transport masts is enabled and the system can be used without the upper storage unit having been installed or after it has been removed. The present system can thus advantageously be flexibly adapted to the needs of the user.

In particular, if less storage space is required, it is possible to easily remove or never install the upper storage unit and use only the lower storage unit. Nevertheless, in case demand increases, it is possible to add an upper storage unit and the necessary parts of the conveyor system at any time so that the capacity of the system can easily be increased.

In a second aspect the present invention is directed to a method of assembling of a storage and commissioning system. The method comprises the step of detachably arranging an upper storage unit on top of a lower storage unit to form a storage arrangement for receiving storage containers comprising goods. Each storage unit is based on a self-supporting frame structure. The self-supporting frame structure of the lower storage unit is set up for supporting the upper storage unit. The method further comprises the step of releasably connecting a commissioning unit and a conveyor system to the storage arrangement. The commissioning unit comprises at least one serving station for removing goods from one or more storage containers. The conveyor system conveys storage containers between the storage arrangement and the commissioning unit. The conveyor system is detachably connected to the self-supporting frame structures of the lower storage unit and the upper storage unit.

The upper storage unit may be placed directly or indirectly on top of the lower storage unit, i.e., one or more additional storage units may be placed on top pf the lower storage unit and the upper storage unit is placed on top of these additional storage units.

Releasably connecting the conveyor system to the storage arrangement preferably comprises releasably connecting a first modular transport mast which is movable horizontally along a first side of the storage arrangement for conveying storage containers between the first side of the storage arrangement and the commissioning unit and preferably connecting a second modular transport mast which is movable horizontally along a second side of the storage arrangement opposite the first side of the storage arrangement for conveying storage containers between the second side of the storage arrangement and the commissioning unit.

To form the first and/or the second modular transport mast, a lower mast section is preferably connected via a center mast section to an upper mast section to form the respective modular transport mast.

It is further preferred to attach one and preferably two or more container handling devices for transporting storage containers to at least one of the first modular transport mast and the second modular transport mast. The preferred two or more container handling devices move concurrently vertically along the respective modular transport mast.

Releasably connecting the conveyor system to the storage arrangement preferably comprises for each modular transport mast, releasably mounting a set of guide rails to the storage arrangement and releasably connecting the respective modular transport mast via the set of guide rails to the transport arrangement, wherein the first set of guide rails enables horizontal movement of the respective modular transport mast along the first side of the transport arrangement.

Releasably mounting at least one set of guide rails comprises preferably mounting at least one lower guide rail to the lower storage unit and at least one upper guide rail to the upper storage unit.

The preferred embodiments of the method for assembling a modular storage and commissioning system preferably result embodiments of a storage and commissioning systems which correspond to those that have previously been described. As such, the advantages of the respective embodiments of the method for assembling the system correspond to the advantages of the obtained system.

In a third aspect, the invention is directed to a method of disassembling a storage and commissioning system assembled according to the preceding embodiment. For each transport mast, the respective upper mast section is disconnected from the respective center mast section and the respective center mast section is disconnected from the respective lower mast section. All upper guide rails are detached from the upper storage unit. The upper storage unit is removed from the lower storage unit. The upper guide rails are attached to the lower storage container. For each transport mast the lower mast section is connected directly or via an alternative center mast section to the upper mast section to form a short transport mast. The short transport mast is connected to the lower guide rail and the upper guide rail at the lower storage unit so that the short transport masts can be used for conveying storage containers from the lower storage unit to the commissioning unit after the upper storage unit has been detached from the lower storage unit.

The exemplary embodiment of a method for disassembling a storage and commissioning unit previously assembled according to one of the exemplary embodiments of the method, result in an embodiment of a partially disassembled storage and commissioning system. In particular, the conveyor unit has been at least partially removed and the upper storage unit has also been removed from the lower storage unit resulting in a storage and commissioning system which comprises only the lower storage unit and a conveyor unit which is nevertheless able to operate the system. Thus, even after the system has been partially disassembled it can still be used for retrieving transport containers from the lower storage unit and conveying them to the commissioning unit or transporting storage containers from the commissioning unit back to the lower storage unit. Thereby, the system can also be used with less capacity while the upper part of the system can already be reused.

It is noted that individual steps of the exemplary embodiments of the methods for assembling and disassembling a storage and commissioning system do not necessarily have to be carried out in the exact order unless such requirement can be specifically derived from the claims or technical necessities.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic line drawing of an exemplary embodiment of a modular storage and commissioning system without a commissioning unit;

FIG. 2 is a schematic drawing of an exemplary embodiment of a modular storage and commissioning system which has been partially disassembled;

FIG. 3 is a schematic drawing of an exemplary embodiment of a commissioning unit; and

FIG. 4 is a flow diagram of a method for assembling and disassembling a modular storage and commissioning system.

### DESCRIPTION OF PREFERRED EMBODIMENTS

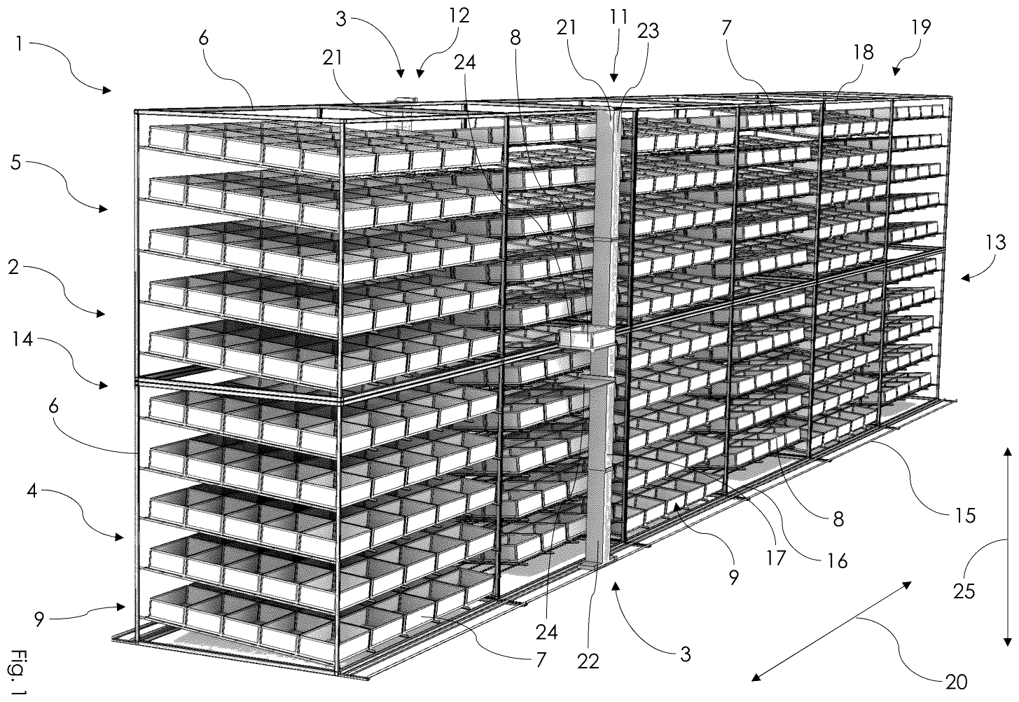

Referring to the drawings, FIG. 1 shows an exemplary embodiment of a modular storage and commissioning system 1. The system 1 comprises a storage arrangement 2 and a conveyor system 3. The modular storage and commissioning system 1 further comprises a commissioning unit which is, however, not shown in FIG. 1 as it would obstruct the view onto the storage arrangement 2 and conveyor system 3.

The storage arrangement 2 comprises a lower storage unit 4 and an upper storage unit 5, i.e. a first storage unit 4 and a second storage unit 5. Each of the storage units 4, 5 is made up from a self-supporting frame structure 6 inside which the actual storage positions 7 for storage containers 8 are formed. In FIG. 1 only selected storage positions 7 and storage containers 8 are designated with reference numerals to keep the figure intelligible.

The storage containers 8 are provided for receiving and storing various kinds of goods which may also be referred to as items or articles. The storage containers 8 are transported using the conveyor system 3 to the not-shown commissioning unit so that an operator can collect goods from the storage containers 8 in order to fulfill an order or another supply request.

In the exemplary embodiment shown in FIG. 1, the storage positions 7 for receiving the transport containers 8 are formed as so-called flow-through channels 9. The flow-through channels 9 can, for example, comprise a floor element 10 which is tilted from one side of the storage unit 4, 5 towards the other. A storage container or storage box 8 which is placed on a floor element 10 of a through-flow channel 9 will thus be pulled by gravity towards the lower end of the respective through-flow channel 9. Thereby, it is ensured that all storage containers 8 which have been placed in the same through-flow channel 9 automatically move to one of the two sides of the storage units 4, 5. Here, the storage containers 8 can be retrieved using the conveyor system 3 which is provided with appropriate means.

Once again, in order to keep FIG. 1 intelligible, only selected through-flow channels 9 and flow elements 10 have been designated with reference numerals.

The storage units 4, 5 are, as previously mentioned, based on self-supporting frame structures 6. The self-supporting frame structures 6 are formed in the exemplary embodiment shown in the figures by an outer frame structure. The storage units 4, 5 are generally of cuboid shape and their dimensions correspond to those of a forty-foot shipping container. This advantageously allows transporting the storage units when the modular storage and commissioning system has been disassembled easily using conventional cargo tracks.

The self-supporting frame structure 6 of each storage unit 4, 5 is strong enough to support the weight of at least one further storage unit 4, 5. In the exemplary embodiment shown in FIG. 1, the upper storage unit 5 has been placed on the lower storage unit 4 so that the entire weight of the upper storage unit 5 including any storage containers 8 and goods located in the storage containers 8 has to be carried by the self-supporting frame structure 6 of the lower storage unit 4. In other words, the self-supporting frame structure 6 of the lower storage unit 4 has to be capable of bearing more than double the weight of the lower storage unit 4.

The upper and lower storage unit 4, 5 are releasably attached to one another, for example, using brackets. As such, after removing the brackets or other kinds of connections between the upper storage unit 5 and the lower storage unit 4, the upper storage unit 5 can be removed from the lower storage unit 4 and be used, for example, as part of a different modular storage and commissioning system 1. In order to keep the system 1 as flexible as possible, the lower storage unit 4 and the upper storage unit 5 are essentially identical. In particular, the self-supporting frame structure 6 of the upper storage unit 5 is also sufficiently strong to support another storage unit, for example, the lower storage unit 4, so that the positions of the lower storage unit 4 and the upper storage unit 5 can be interchanged or another storage unit can be placed on the upper storage unit 5 when it is used in the place of the lower storage unit 4 in a different modular storage and commissioning system 1.

The conveyor system 3 is formed from a first conveyor unit 11 and a second conveyor unit 12. The first conveyor unit 11 is releasably attached to the storage arrangement 2 on a first side 13 thereof. Correspondingly, the second conveyor unit 12 is releasably attached or connected to a second side 14 of the storage arrangement 2. To this end, each of the conveyor units 11, 12 comprises a frame 15 with two guide rails 16, 18. The guide rails 16, 18 may also be referred to as a lower guide rail 16 and an upper guide rail 18. The combination of the lower guide rail 16 and the upper guide rail 18 thus forms on each conveyor unit 11, 12 a set 19 of guide rails 16, 18.

The guide rails 16, 18 are releasably attached to the storage arrangement 2 after the upper storage unit 5 has been placed on the lower storage unit 4 and the two have been releasably connected. Once mounted, the guide rails 16, 17, 18 facilitate horizontal movement, i.e. movement in a horizontal direction 20, of modular transport mast 21 along the first and the second side 13, 14 of the storage arrangement 2. In FIG. 1 only the modular transport mast 21 attached to the first side 13 of the storage arrangement 2 can be seen. However, the second modular transport mast attached to the second side 14 of the storage arrangement 2 is of identical configuration. Hence, the following description of the transport mast 21 also applies to the transport mast attached to the second side 14.

The modular transport mast 21 is formed from a lower transport mast section 22, a center transport mast section 17 and an upper transport mast section 23. In the exemplary embodiment shown in FIG. 1 the upper transport mast section 23 is connected to the lower transport mast section 22 via the center transport mast section 17 during assembly of the modular storage and commissioning system 1. The connection between the lower transport mast section 22, the center transport mast section 17 and the upper transport mast section 23 is releasable so that the mast sections 17, 22, 23 can be disconnected from one another when the modular storage and commissioning system 1 is (partially) disassembled.

In operation, the lower transport mast section 22 engages with the lower guide rail 16. Correspondingly, the upper transport mast section 23 engages with the upper guide rail 18. Rollers or other means facilitating movement of the transport mast 21 in the horizontal direction 20 are provided at the respective upper and lower ends of the upper and lower transport mast sections. The upper and lower transport mast sections 22, 23 can only move together as they are connected to one another via the center mast section 17.

To facilitate conveying storage containers 8 from the storage arrangement 2, the modular transport mast 21 comprises two container handling devices 24. Each of the container handling devices 24 can collect one transport container from the storage arrangement 2. Both container handling devices 24 can move vertically, i.e. in a vertical direction 25 along the entire modular transport mast 21. The movement of the two container handling devices 24 occur concurrently and independently of one another but is limited by the position of the respective other container handling device 24. However, each container handling device 24 is capable of collecting storage containers 8 from either the upper storage unit 5 or the lower storage unit 4.

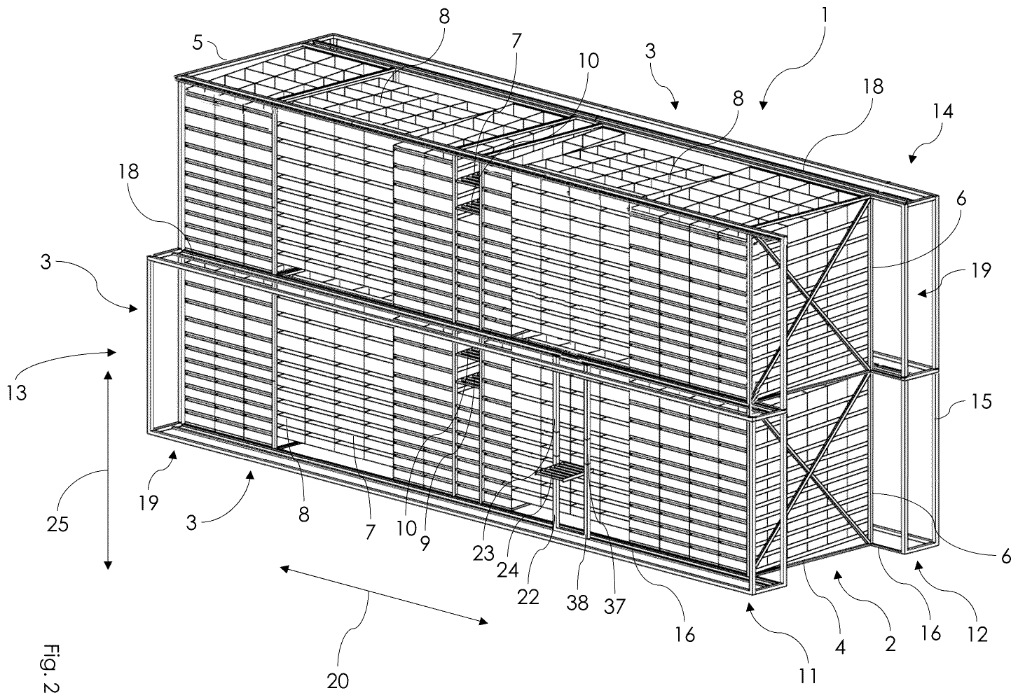

FIG. 2 shows an exemplary embodiment of a storage and commissioning system 1 in a partially disassembled state. For example, when only a reduced number of storage positions 7 is required after some time, the modular storage and commissioning system 1 can be partially disassembled by removing the upper storage unit 5 as well as part of the conveyor system 3. The removed parts of the system 1 can be used in a different location either independently or as part of a further modular storage and commissioning system. As will be explained now with reference to FIG. 2, if the system 1 has been partially disassembled by removing the upper storage unit 5, the remaining system 1 can be kept functional and thus still be used to store and retrieve goods for commissioning.

The system 1 shown in FIG. 2 is very similar to the system shown in FIG. 1. Therefore, in order to avoid unnecessary repetitions, only those aspects of FIG. 2 will be described in more detail which differ from FIG. 1. In FIGS. 1 and 2 identical elements are designated with the same reference numerals.

In FIG. 2, disassembly of the modular storage and commissioning system 1 of FIG. 1 has begun. The disassembly has only partially progressed and so far resulted in removal of part of the frame 15 of the first conveyor unit 11 that was previously attached to the first side 13 of the storage arrangement 2. Concretely, the upper guide rail 18 attached to the upper storage unit 5 has already been detached from the upper storage unit 5 and mounted to the upper end of the lower storage unit 4 where the lower storage unit 4 interfaces with the upper storage unit 5.

Further, the upper transport mast section 23 and the center transport mast section 17 and one of the container handling devices 24 have been disconnected from the lower transport mast section 22. The upper transport mast section 23 has, however, been reattached to the lower transport master section 22 using an alternative center transport mast section 37 to form a short transport mast 38. The short transport mast 38 extends from the lower guide rail 16 to the relocated upper guide rail 18 and can be used to convey goods between the lower storage unit 4 and the commissioning unit 26.

Thus, after partial disassembly the first conveyor unit 11 comprises a lower guide rail 16 and an upper guide rail 18 to which the short transport mast 38 with a single container handling device 24 are attached. Due to the modular character of the present system 1, the short modular transport mast 38 can be used to convey goods between the first side 13 of the lower storage unit 4 and the commissioning unit (not shown). Hence, the system 1 can still be used after it has been partially disassembled. Notably, only the center mast section 17 needs to be exchanged for reusing the transport mast 21, 38, while the more complex upper and lower mast sections 22, 23 which provide the connection of the transport mast 21, 38 to the guide rails 16, 17 can be reused.

It is noted that in FIG. 2 only one container handling device 24 is shown on the short transport mast 38. However, it is also conceivable that multiple container handling devices 24 are operated on the short mast 38 so that the number of storage containers 8 that can be transported simultaneously with the short transport mast 38 can be increased.

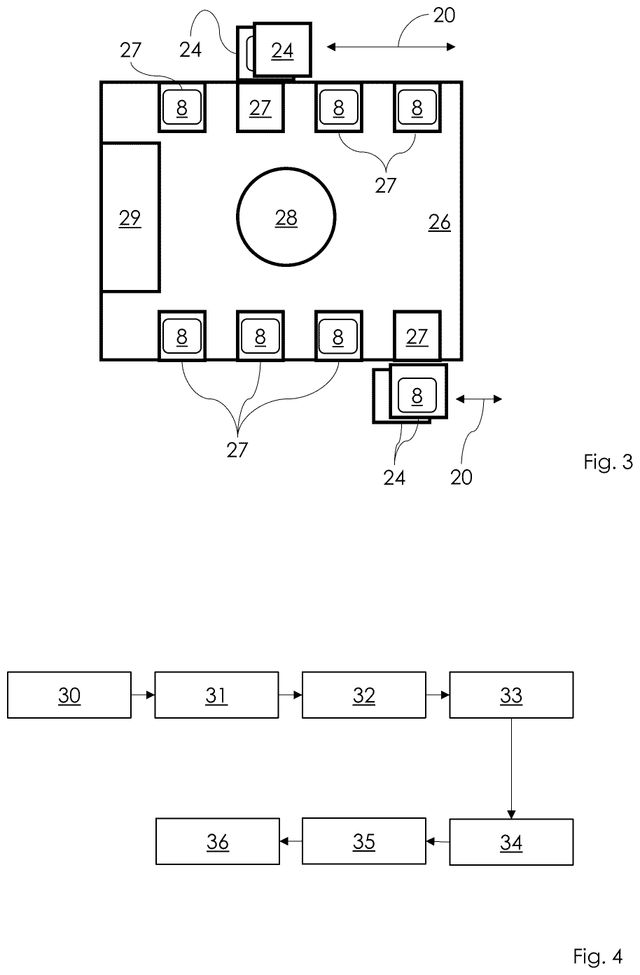

FIG. 3 shows a schematic drawing of an exemplary embodiment of a commissioning unit 26 which is part of the storage and commissioning system 1 shown in FIGS. 1 and 2. The commissioning unit 26 comprises eight serving stations 27. Hence, the conveyor units 11, 12 of which only the container handling devices 24 are shown in FIG. 3 can drop off and retrieve storage containers 8. An operator 28 of the commissioning unit 26 can then collect goods (not shown) stored in the storage containers 8 and drop them off at a fulfillment or target position 29. The operator 28 can be a human operator or a robotic operator. Further, in the exemplary embodiment shown in FIG. 3, the commissioning unit 26 comprises two serving stations 27 for each container handling device 24 so that the conveyor unit 3 can always drop off one storage container 8 and collect another one from a different serving station 27 when moving between the commissioning unit 26 and the transport arrangement 2.

With reference to FIG. 4 an exemplary embodiment of a method for assembling as well as an exemplary embodiment of a method for disassembling a storage and commissioning system 1 will now be described. The method will be described with reference to the embodiments of storage and commissioning systems 1 shown in FIGS. 1 and 2.

In a first step 30 a lower storage unit 4 is placed, for example, in a warehouse. In a second step 31 an upper or second storage unit 5 is placed on top of the lower storage unit 4. The lower and upper storage units 4, 5 are releasably connected, for example, using lugs or container twist locks to form a storage arrangement 2.

In a third step 32 conveyor units 11, 12 are connected to the sides 13, 14 of the storage arrangement 2. As part of the third step, a first set 19 of guide rails 16, 18 is attached to the first side 13 of the storage arrangement 2. Similarly, a second set 19 of guide rails 16, 18 is also attached to the second side 14 of the storage arrangement 2. Attaching the sets 19 of guide rails 16, 18 to the storage arrangement 2, and more concretely to the storage units 4, 5 includes mounting a lower guide rail 16 on each side 13, 14 of the lower storage unit and mounting an upper guide rail 18 on each side 13, 14 of the upper storage unit 5.

Once the sets 19 of guide rails 16, 18 have been mounted to the storage arrangement 2, in a fourth step 33 modular transport masts 21 are mounted to the guide rails 16, 18. Before the modular transport masts 21 can be attached to the guide rails 16, 18, the transport masts 21 have to be assembled from a lower mast section 22, a center mast section 17 and an upper mast section 23. To this end, the lower mast section 22 is releasably connected via the center mast section 17 to the upper mast section 23.

Once a transport mast 21 has been assembled and mounted to the storage arrangement 2, the lower mast section 22 is connected to and guided by the lower guide rail 16, whereas the upper transport mast section 23 is connected to and guided by the upper guide rail 18. The center mast section 17 is not connected to any guide rail in the exemplary embodiment.

Finally, in a fifth step 34 at least two container handling devices 24 are attached to the modular transport mast 21. Since the modular transport mast 21 can move in a horizontal direction along the first or the second side 13, 14 of the storage arrangement 2 and the container handling devices 24 can move in a vertical direction 25 along one of the sides 13, 14 of the storage arrangement 2, the so constructed conveying system 3 can be used to retrieve storage containers 8 from any position in the storage arrangement 2.

Once the system 1 is no longer fully or partially required, it can be disassembled. In a first step 35 of an exemplary method of disassembling the storage and commissioning system 1 previously assembled, the conveyor units 11, 12 are partially disconnected from the storage arrangement 2. Partially disconnecting the conveyor units 11, 12 here includes disconnecting the upper mast section 23 and the center mast section 17 from the lower mast section 22. The center mast section 17 is then replaced by an alternative center mast section 37 to form a short transport mast 38. The height of the short transport mast 38 corresponds to the height of the lower storage unit 4.

In a second step 36 of a method for disassembling a storage and commissioning system 1 previously assembled, the upper guide rails 18 of the first and second conveyor unit 11, 12 are removed from the upper storage unit 5 of the storage arrangement 2 and attached to an upper end of the lower storage unit 4. Since the short transport mast 38 can then be attached to the existing lower guide rail 16 and the newly mounted upper guide rail 18. Advantageously, the connections between the guide rails 16, 18 provided at the lower and upper sections 22, 23 of the transport mast 21 can be used both for the regular transport mast 21 and the short transport mast 38. The modular storage and commissioning system 1 thus remains partially operational even when it has been partially disassembled. As previously mentioned, storage containers 8 can still be removed from or placed into the lower storage unit 4.

While specific embodiments of the invention have been shown and described in detail to illustrate the application of the principles of the invention, it will be understood that the invention may be embodied otherwise without departing from such principles.

### LIST OF REFERENCE NUMERALS

1 modular storage and commissioning system
2 storage arrangement
3 conveyor system
4 lower storage unit
5 upper storage unit
6 self-supporting frame structure
7 storage position
8 storage container
9 through-flow channel
10 floor element
11 first conveyor unit
12 second conveyor unit
13 first side of the storage arrangement
14 second side of the storage arrangement
15 frame of a conveyor unit
16 lower guide rail
17 center transport mast section
18 upper guide rail
19 set of guide rails
20 horizontal direction
21 modular transport mast
22 lower transport mast section
23 upper transport mast section
24 container handling device
25 vertical direction
26 commissioning unit
27 serving station
28 operator
29 target position
30 first step
31 second step
32 third step
33 fourth end
34 fifth step
35 first step
36 second step
37 alternative center transport mast section
38 short transport mast

1. A modular storage and commissioning system comprising:
a storage arrangement for receiving storage containers comprising goods;
a commissioning unit with a least one serving station for removing goods from one or more storage containers; and
a conveyor system for conveying storage containers between the storage arrangement and the commissioning unit wherein the storage arrangement comprises a lower storage unit and an upper storage unit each storage unit being based on a self-supporting frame structure, wherein the conveyor system is detachably connected to the self-supporting frame structures of the lower storage unit and the upper storage unit, wherein the self-supporting frame structure of the lower storage unit is adapted for supporting the upper storage unit and wherein the upper storage unit is detachably arranged on top of the lower storage unit.

2. A modular storage and commissioning system according to claim 1, wherein the lower storage unit and the upper storage unit each have a cuboid outer shape and identical outer dimensions.

3. A modular storage and commissioning system according to claim 1, wherein the conveyor system comprises a first modular transport mast which is movable horizontally along a first side of the storage arrangement for conveying storage containers between the first side of the storage arrangement and the commissioning unit and wherein the conveyor system further comprises a second modular transport mast which is movable horizontally along a second side of the storage arrangement for conveying storage containers between the second side of the storage arrangement and the commissioning unit, the second side being opposite the first side.

4. A modular storage and commissioning system according to claim 3, wherein each modular transport mast comprises:
a lower mast section;
a center mast section; and
an upper mast section, wherein the upper mast section is detachably connected via the center mast section to the lower mast section.

5. A modular storage and commissioning system according to claim 4, wherein for each transport mast the lower mast section can be detachably connected to the upper mast section either directly or using an alternate center mast section to form a short transport mast so that when the upper storage unit has been removed from the lower storage unit, storage containers can be conveyed between the lower storage unit and the commissioning unit using the short transport mast.

6. A modular storage and commissioning system according to claim 3, wherein each modular transport mast comprises at least one or more container handling devices, wherein each of the container handling devices is configured to move vertically along the respective modular transport mast.

7. A modular storage and commissioning system according to claim 6, wherein the commissioning unit comprises at least on serving station for each container handling device, wherein the serving stations are configured for temporarily receiving a storage container from at least one of the container handling devices and enabling an operator of the commissioning unit to remove goods from a storage container placed on a serving station.

8. A modular storage and commissioning system according to claim 3, wherein the system comprises two commissioning units and wherein the conveying system is configured so that the first transport mast and/or the second transport mast may convey goods between both commissioning units and the storage arrangement.

9. A modular storage and commissioning system according to claim 3, wherein the conveyor system comprises for each transport mast a set of guide rails for releasably connecting the first modular transport mast to the storage arrangement and for enabling horizontal movement of the first modular transport mast along the storage arrangement.

10. A modular storage and commissioning system according to claim 9, wherein each set of guide rails comprises at least one lower guide rail and at least one upper guide rail, wherein the at least one lower guide rail is mounted to the lower storage unit and configured for engaging with the lower mast section and wherein the at least one upper guide rail is mounted to the upper storage unit and configured for engaging with the upper mast section.

11. A modular storage and commissioning system according to claim 10, wherein each modular transport mast comprises: a lower mast section; a center mast section; and an upper mast section, wherein the, wherein for each transport mast the lower mast section can be detachably connected to the upper mast section either directly or using an alternate center mast section to form a short transport mast so that when the upper storage unit has been removed from the lower storage unit, storage containers can be conveyed between the lower storage unit and the commissioning unit using the short transport mast, wherein each upper guide rail is configured such that when the upper storage unit has been removed from the lower storage unit, the respective upper guide rail can be mounted to the lower storage unit such that the short transport mast can be connected via the lower guide rail and the upper guide rail to the lower storage unit.

12. A method for assembling a modular storage and commissioning system, the method comprising the steps of:
detachably arranging an upper storage unit on top of a lower storage unit to form a storage arrangement for receiving storage containers comprising goods, wherein each storage unit is based on a self-supporting frame structure and wherein the self-supporting frame structure of the lower storage unit is adapted for supporting the upper storage unit; and
releasably connecting a commissioning unit and a conveyor system to the storage arrangement, wherein the commissioning unit comprises a least one serving station for removing goods from one or more storage containers, wherein the conveyor system conveys storage containers between the storage arrangement and the commissioning unit, and wherein the conveyor system is detachably connected to the self-supporting frame structures of the lower storage unit and the upper storage unit.

13. A method according to claim 12, wherein releasably connecting the conveyor system to the storage arrangement comprises releasably connecting a first modular transport mast which is movable horizontally along a first side of the storage arrangement for conveying storage containers between the first side of the storage arrangement and the commissioning unit.

14. A method according to claim 13, wherein to form the first and/or the second modular transport mast, a lower mast section is connected via a center mast section to an upper mast section to form the respective modular transport mast.

15. A method according to claim 13, wherein the method further comprises attaching one or more container handling devices for transporting storage containers to at least one of the first modular transport mast and the second modular transport mast, wherein the container handling devices move concurrently vertically along the respective modular transport mast.

16. A method according to claim 13, wherein releasably connecting the conveyor system to the storage arrangement comprises for each modular transport mast, releasably mounting a set of guide rails to the corresponding side of the storage arrangement and releasably connecting the respective modular transport mast via the set of guide rails to the transport arrangement, wherein the set of guide rails enables horizontal movement of the respective modular transport mast along the respective side of the transport arrangement.

17. A method according to claim 16, wherein releasably mounting at least one set of guide rails comprises mounting at least one lower guide rail to the lower storage unit and at least one upper guide rail to the upper storage unit.

18. A method for disassembling a modular storage and commissioning system assembled according to claim 17, the method comprising the steps of:
for each transport mast, disconnecting the respective upper mast section from the respective center mast section and disconnecting the respective center mast section from the respective lower mast section;
detaching all upper guide rails from the upper storage unit;
removing the upper storage unit from the lower storage unit;
attaching the upper guide rails to the lower storage container,
for each transport mast, connecting the lower mast section directly or via an alternative center mast section to the upper mast section to form a short transport mast,
connecting the short transport mast to the lower guide rail (16) and the upper guide rail at the lower storage unit so that the short transport masts can be used for conveying storage containers from the lower storage unit to the commissioning unit after the upper storage unit has been detached from the lower storage unit.

19. A storage and commissioning system according to claim 6, wherein each modular transport mast comprises two or more container handling devices, wherein the container handling devices are further structurally linked so that the container handling devices stay at a constant distance relative to one another while moving along the respective modular transport mast or wherein the two or more container handling devices are further configured to move independently but concurrently on the respective modular transport mast.

20. A method according to claim 13, wherein releasably connecting the conveyor system to the storage arrangement comprises releasably connecting a second modular transport mast which is movable horizontally along a second side of the storage arrangement opposite the first side of the storage arrangement for conveying storage containers between the second side of the storage arrangement and the commissioning unit.
